(19) United States
(12) Patent Application Publication
(10) Pub. No.: US 2017/0261619 A1
(43) Pub. Date: Sep. 14, 2017

(54) GLOBAL NAVIGATION SATELLITE SYSTEM ANTENNA

(71) Applicant: AeroAntenna Technology, Inc., Chatsworth, CA (US)

(72) Inventor: Joe Klein, Chatsworth, CA (US)

(21) Appl. No.: 15/452,001

(22) Filed: Mar. 7, 2017

Related U.S. Application Data
(60) Provisional application No. 62/305,638, filed on Mar. 9, 2016.

(51) Int. Cl. G01S 19/36

(52) U.S. Cl. CPC G01S 19/36

(57) ABSTRACT

A system for facilitating installation of a global navigation satellite system (GNSS) antenna on an aircraft may include, a GNSS antenna, a transducer, a cable operably coupling the GNSS antenna to the transducer, and a global positioning systems (GPS) receiver operably coupled to the transducer.

### CROSS REFERENCE TO RELATED APPLICATIONS

This application claims priority to U.S. application Ser. No. 62/305,638 filed Mar. 9, 2016, the entire contents of which are hereby incorporated by reference in its entirety.

### TECHNICAL FIELD

Various example embodiments relate generally to antenna technology, and more particularly relate to a global navigation satellite system (GNSS) antenna.

### BACKGROUND

Aircraft may have navigation equipment on board that interfaces with other equipment located at ground based, satellite based, or aircraft based sites via antennas. The navigation equipment may be regulated by the FAA or other government agencies. However, the current standard under which navigation equipment is regulated is changing to accommodate the global navigation satellite system (GNSS). GNSS uses multiple satellites in order to locate the aircraft. Antenna structures may not be designed to accommodate the GNSS, and manufacturers of aircrafts may not understand how to properly install a GNSS antenna.

### SUMMARY

A system for facilitating installation of a global navigation satellite system (GNSS) antenna on an aircraft may include, a GNSS antenna, a transducer, a cable operably coupling the GNSS antenna to the transducer, and a global positioning systems (GPS) receiver operably coupled to the transducer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example embodiment of an installation of a GPS system according to the pre-GNSS standards that is known in the prior art;

FIG. 2A illustrates an example embodiment of a block diagram of an installation of a GNSS; and

FIG. 2B illustrates a further example embodiment of a block diagram of an installation of a GNSS; and

FIG. 3 illustrates an even further example embodiment of a block diagram of an installation of a GNSS.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

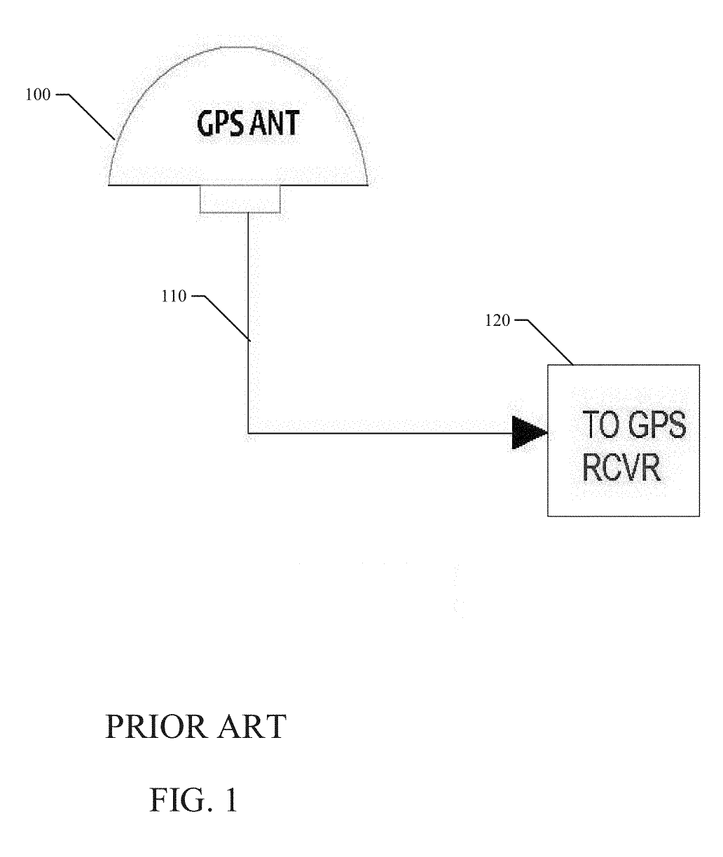

FIG. 1 illustrates an example embodiment of an installation of a GPS system according to the pre-GNSS standards that is known in the prior art. As shown in FIG. 1, the system may include a GPS antenna 100, a cable 110, and a GPS receiver 120. The GPS antenna 100 may be operably coupled by the cable 110 to the GPS receiver 120.

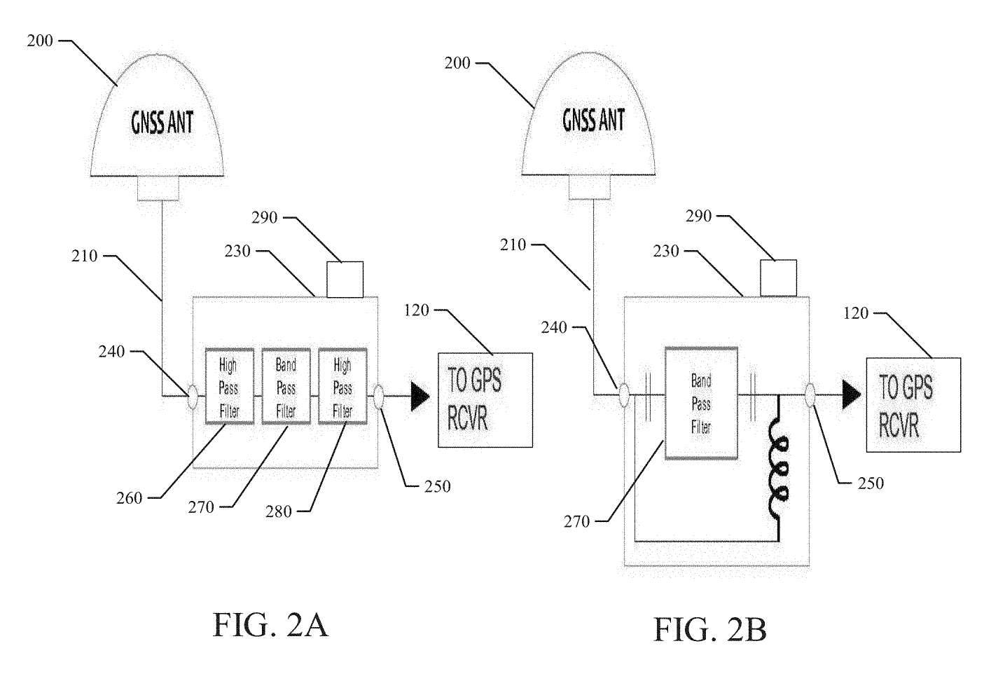

FIG. 2A illustrates an example embodiment of an installation of a system having a GNSS antenna 200. As shown in FIG. 2A, the system may include a GNSS antenna 200, a cable 210, a transducer 230, and the GPS receiver 120. In some cases, the system may also include an external DC supply 290 to supply the required DC current or voltage needed by the system in the event the GPS receiver 120 cannot.

As shown in FIG. 2A, the cable 210 may operably couple the transducer 230 to the GNSS antenna 200 at a first connection 240 and to the GPS receiver 120 at a second connection 250. In particular, the transducer 230 will filter the signal from the GNSS antenna 200 before it is received by the GPS receiver 120. The transducer 230 may include a first and second high pass filter 260, 280 and a band bass filter 270. The signal from the GNSS antenna 200 will be filtered initially through the first high pass filter 260, then through the band pass filter 270, and then finally the second high pass filter 280 before being sent to the GPS receiver 120. In further example embodiments, as shown in FIG. 2B, the transducer 230 may only include the band pass filter 270 which filters the signal from the GNSS antenna 200 before sending it to the GPS receiver 120.

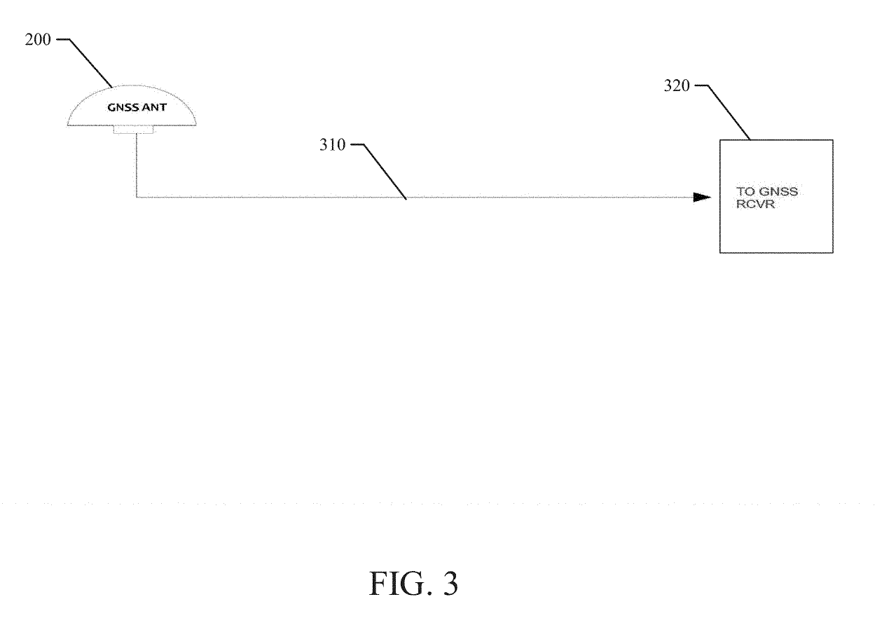

FIG. 3 illustrates an even further example embodiment of an installation of system having a GNSS antenna. As shown in FIG. 3, the system may include a GNSS antenna 200, a cable 310, and a GNSS receiver 320. When the GNSS antenna 200 and the GNSS receiver 320 are used in the installation, no transducer is needed and the cable 310 operably couples the GNSS antenna 200 directly to the GNSS receiver 320.

Some example embodiments, therefore, may provide a capable system for aircraft antenna installation to support multiple satellites such as in a GNSS and that may allow GNSS receivers to replace GPS receivers with minimal effort to improve system performance. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A system comprising:
a global navigation satellite system (GNSS) antenna;
a transducer;
a cable operably coupling the GNSS antenna to the transducer; and
a global positioning systems (GPS) receiver operably coupled to the transducer.

2. The system of claim 1, further comprising a DC supply operably coupled to the transducer to supply DC current or voltage to the system.

3. The system of claim 1, wherein the cable operably couples the transducer to the GNSS antenna at a first connection and operably couples the transducer to the GPS receiver at a second connection.

4. The system of claim 3, wherein the transducer filters a signal from the GNSS antenna before it is received by the GPS receiver.

5. The system of claim 4, wherein the transducer includes a first high pass filter, a second high pass filter, and a band bass filter.

6. The system of claim 5, wherein the signal from the GNSS antenna is filtered initially through the first high pass filter, then through the band pass filter, and then finally through the second high pass filter before the signal is sent to the GPS receiver 120.

7. The system of claim 4, wherein the transducer comprises only a band pass filter configured to filter the signal from the GNSS antenna before sending the signal to the GPS receiver.
